(19) United States
(12) Patent Application Publication
(10) Pub. No.: US 2018/0024723 A1
(43) Pub. Date: Jan. 25, 2018

(54) SYNCHRONIZING USER INPUT WITH A USER INTERFACE

(71) Applicant: Red Hat, Inc., Raleigh, NC (US)

(72) Inventors: Martin Vecera, Brno (CZ); Jiri Pechanec, Mokra-Horakov (CZ)

(21) Appl. No.: 15/213,705

(22) Filed: Jul. 19, 2016

(51) Int. Cl. G06F 3/0484; G06F 3/0488; G06F 9/44; G06F 3/0482

(52) U.S. Cl. CPC G06F 3/04842; G06F 3/0482; G06F 3/0488; G06F 9/4443

(57) ABSTRACT

Synchronizing user input with a user interface is disclosed. User input that identifies a selected location on a display device that is presenting a first user interface (UI) is received at the first time. A user input record that includes a location identifier that identifies the selected location, and a user input timestamp that identifies the first time, is stored in a memory. At a second time, a second UI is presented on the display device that is different from the first UI. The second UI includes a user-activatable UI portion having an activatable extent that includes the selected location. After the second time, processing of the user input record is initiated. It is determined that the user input timestamp identifies a time earlier than the second time, and activation of the user-activatable UI portion is inhibited.

### TECHNICAL FIELD

The examples relate generally to user interfaces, and in particular to synchronizing user input with a user interface.

### BACKGROUND

Computing devices, such as computers, smartphones, computing tablets, and the like, often facilitate interaction with a user via a user interface that is presented on a display device. The user interface (UI) typically includes one or more user-activatable UI portions that, if selected by the user, such as via a click of a mouse or a touch of a finger, cause a new UI to be presented. For example, user activation of a user-activatable link to a web page typically results in the web page being displayed on the display device, resulting in a different UI than existed prior to the user activation of the user-activatable link.

### SUMMARY

The examples, among other features, synchronize user input with a user interface (UI) presented on the display device at the time of the user input. In particular, the examples ensure that a user-activatable UI portion that was presented on a display device after the receipt of the user input is not activated in response to the user input received before the presentation of the user-activatable UI portion.

In one example a method is provided. The method includes receiving, at a first time, user input that identifies a selected location on a display device that is presenting a first UI at the first time. The method further includes storing, in a memory, a user input record that includes a location identifier that identifies the selected location and a user input timestamp that identifies the first time. The method further includes presenting, at a second time, on the display device a second UI that is different from the first UI, the second UI including a user-activatable UI portion having an activatable extent that includes the selected location. The method further includes initiating, after the second time, processing of the user input record. The method further includes determining that the user input timestamp identifies a time earlier than the second time, and inhibiting activation of the user-activatable UI portion.

In another example a computing device is provided. The computing device includes a memory and a processor device coupled to the memory. The processor device is to receive, at a first time, user input that identifies a selected location on a display device that is presenting a first UI at the first time. A user input record that includes a location identifier that identifies the selected location and a user input timestamp that identifies the first time is stored in a memory. At a second time a second UI is presented on the display device that is different from the first UI. The second UI includes a user-activatable UI portion having an activatable extent that includes the selected location. After the second time, processing of the user input record is initiated. It is determined that the user input timestamp identifies a time earlier than the second time, and activation of the user-activatable UI portion is inhibited.

In another example a computer program product is provided. The computer program product is stored on a non-transitory computer-readable storage medium and includes instructions configured to cause a processor device to receive, at a first time, user input that identifies a selected location on a display device that is presenting a first UI at the first time. The instructions are further configured to cause the processor device to store, in a memory, a user input record that includes a location identifier that identifies the selected location and a user input timestamp that identifies the first time. The instructions are further configured to cause the processor device to present, at a second time, on the display device a second UI that is different from the first UI, the second UI including a user-activatable UI portion having an activatable extent that includes the selected location. The instructions are further configured to cause the processor device to initiate, after the second time, processing of the user input record. The instructions are further configured to cause the processor device to determine that the user input timestamp identifies a time earlier than the second time, and inhibit activation of the user-activatable UI portion.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which examples may be practiced;

FIG. 2 is a flowchart of a method for synchronizing a user input with a user interface, according to one example;

FIG. 3 is a block diagram of the environment illustrated in greater detail;

FIG. 4 is a block diagram of the environment, according to another example; and

FIG. 5 is a block diagram of a computing device suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first user interface” and “second user interface,” and does not imply a priority, a type, an importance, or other attribute, unless otherwise stated herein. As used herein and in the claims, the articles “a” and “an” in reference to an element refers to “one or more” of the element unless otherwise explicitly specified.

Computing devices, such as computers, smartphones, computing tablets, and the like, often facilitate interaction with a user via a user interface that is presented on a display device. The user interface (UI) typically includes one or more user-activatable UI portions that, if selected by the user, such as via a click of a mouse or a touch of a finger, cause a new UI to be presented. For example, user activation of a user-activatable link to a web page typically results in the web page being displayed on the display device, resulting in a different UI than existed prior to the user activation of the user-activatable link.

Typically a user input is recognized and recorded by a computing device almost instantaneously with the receipt of the user input. At the time of receipt of the user input, a first UI may be presented on the display device, and the user input may have been entered in an effort to activate a user-activatable UI portion of the first UI that was presented to the user at that time. However, although recorded, the user input may not be processed immediately. In particular, under heavy loads, due to poorly written software, or for other reasons, a processor device of a computing device may not be able to process the user input substantially concurrently with the recording of the user input because the processor device is consumed with processing another task. The processing may involve generating a second UI that is then presented on the display device. The processor device, after presenting the second UI, may then process the previously recorded user input. However, under these circumstances, the previously recorded user input may be processed with respect to the second UI rather than the first UI. This may lead to unintended user activation of a user-activatable UI portion of the second UI. The effect of an unintended user activation of a user-activatable UI portion of a UI may range from no practical effect to a catastrophic problem, depending on exactly what the activation caused to happen.

The examples synchronize user input with the UI presented on the display device at the time of user input. In particular, the examples ensure that a user-activatable UI portion that was presented on a display device after the receipt of user input is not activated in response to user input received before the presentation of the user-activatable UI portion.

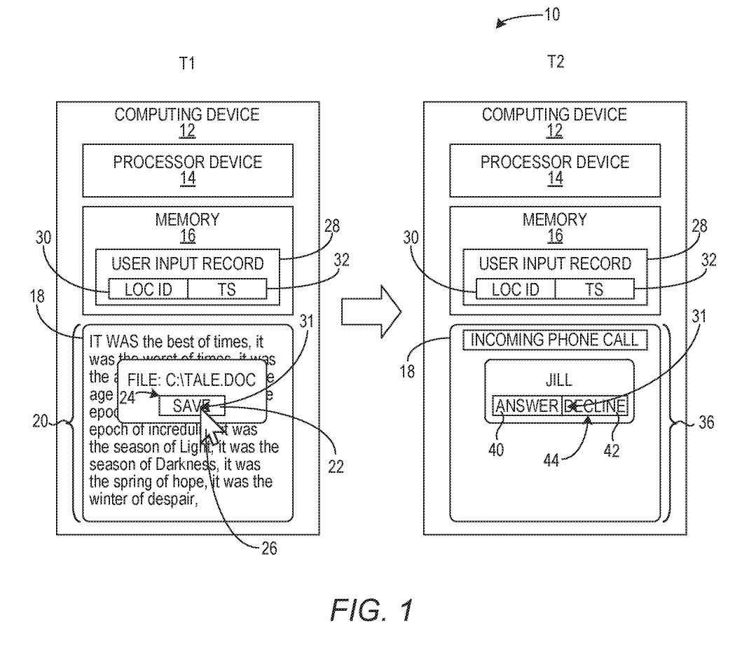

FIG. 1 is a block diagram of an environment 10 in which examples may be practiced. The environment 10 includes a computing device 12 illustrated at two instances in time, a time T1 and a subsequent time T2. The computing device 12 includes a processor device 14, a memory 16, and a display device 18. At the time T1, a first UI 20 is being presented on the display device 18. The display device 18 comprises a plurality of pixels to which the first UI 20 is mapped by the graphics subsystem (not illustrated) of the computing device 12. Thus, each pixel of the display device 18 may be mapped to a particular pixel of the image displayed on the display device 18. The phrase “user interface” is used herein to refer to the image presented on the display device 18 at a given point in time. As used herein, any change to the image displayed on the display device 18 results in a different user interface.

At the time T1, the first UI 20 depicts a user-activatable UI portion 22 that has an activatable extent 24 indicated, in this example, by the rectangular border that surrounds the word “SAVE.” The activatable extent 24 identifies that portion of the first UI 20, which, if selected by a user, will cause the user-activatable UI portion 22 to be activated. The user may activate the user-activatable UI portion 22 by, for example, placing a cursor 26 within the activatable extent 24 and clicking a mouse button of a mouse (not illustrated) that operates in conjunction with the cursor 26. In other examples, the display device 18 may have a touch-sensitive surface and the user may activate the user-activatable UI portion 22 by contacting the activatable extent 24 with a digit of the user.

The computing device 12, upon receiving the user input that activates user-activatable UI portion 22, records the user input in a user input record 28. The user input record 28 includes a location identifier (ID) 30 that identifies a selected location 31 of the display device 18, and a user input timestamp 32 that identifies the time of the user input. The location ID 30 may determine the selected location 31 via, for example, a particular pixel location of the display device 18 at which a tip of the cursor 26 was positioned at the time of the click of the mouse. Often a computing device, such as the computing device 12, may highly prioritize recording a user input, such that even though at the time of receipt of the user input the processor device 14 is occupied with a task, the processor device 14 may be interrupted to generate the user input record 28, and then may return to the task that was interrupted. Alternatively, the computing device 12 may contain an additional processor device (not illustrated) which is dedicated to generating the user input record 28 upon receipt of the user input.

Because the processor device 14 may be heavily loaded, or due to poorly written software, or due to other potential processing anomalies, the processor device 14 may not immediately process the user input record 28 and may, at a time T2 and prior to processing the user input record 28, present a second UI 36 on the display device 18 that announces, in this example, an incoming telephone call. The second UI 36 includes user-activatable UI portions 40 and 42. User selection of the user-activatable UI portion 40 will result in answering of the incoming call, while user selection of the user-activatable UI portion 42 will result in declining the incoming call. Note that the user-activatable UI portion 42 has an activatable extent 44, depicted as a rectangle, that encompasses the selected location 31 selected by the user via the mouse prior to the time T2.

The processor device 14 may now proceed to process the user input record 28. The phrase “process” in this context refers to determining how to respond to the user input, as opposed to merely storing the user input record 28 to record its occurrence. The precise mechanism for processing a user input may differ based on the particular computing device 12 and/or on a particular operating system or windows management system utilized on the computing device 12. Generally, a user input is processed by determining, based on the selected location 31, which application module is responsible for the imagery presented in the UI at the selected location 31, and sending to such application module a message indicating selection of the selected location 31. In conventional computing devices 12, the series of events described herein may result in the processor device 14 processing the user input identified in the user input record 28 with respect to the second UI 36 rather than the first UI 20. Thus, the processor device 14 may send a message that identifies the user input to the application module responsible for processing the phone call in the second UI 36. Because the selected location 31 is within the activatable extent 44, this may result in the computing device 12 declining the phone call, which was not the intent of the user at the time of the user input, since the second UI 36 was not presented on the display device 18 at the time of the user input.

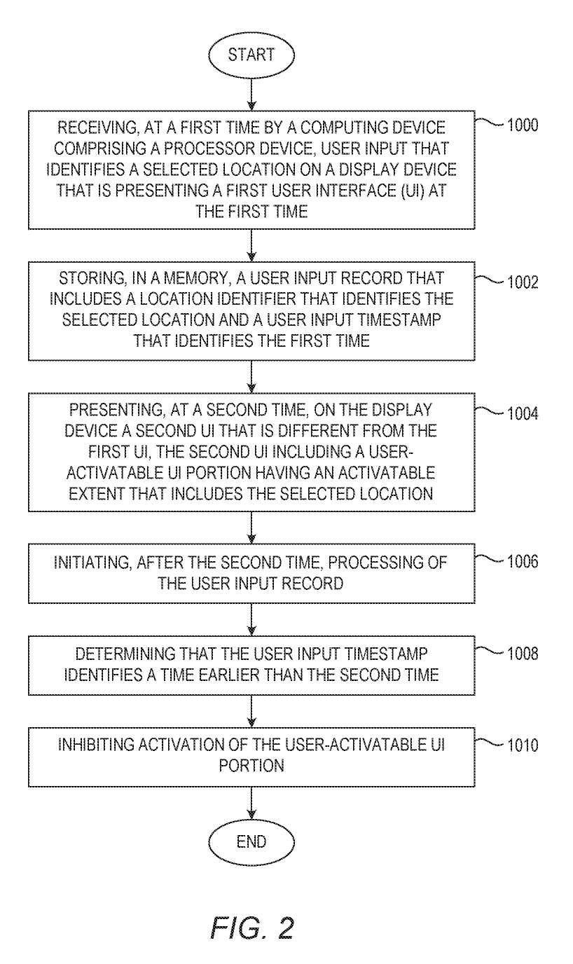

The examples, among other advantages, eliminate the processing of user inputs with respect to a different UI than the UI that was presented on the display device 18 at the time the user input was received. FIG. 2 is a flowchart of a method for synchronizing a user input with a UI, according to one example. FIG. 2 will be discussed in conjunction with FIG. 1. At the time T1, the computing device 12 receives user input that identifies the selected location 31 on the display device 18 that is presenting the first UI 20 at the first time T1 (FIG. 2, block 1000). The computing device 12 stores, in the memory 16, the user input record 28 that includes the location ID 30 that identifies the selected location 31 and the user input timestamp 32 that identifies the first time T1 (FIG. 2, block 1002).

At a second time, T2, the second UI 36 that is different from the first UI 20 is presented on the display device 18. The second UI 36 includes the user-activatable UI portion 42 that has the activatable extent 44 that includes the selected location 31 (FIG. 2, block 1004). After the second time T2, the processor device 14 initiates processing of the user input record 28 (FIG. 2, block 1006). The processor device 14 determines that the user input timestamp 32 identifies a time earlier than the second time T2 (FIG. 2, block 1008). The processor device 14 inhibits activation of the user-activatable UI portion 42 (FIG. 2, block 1010).

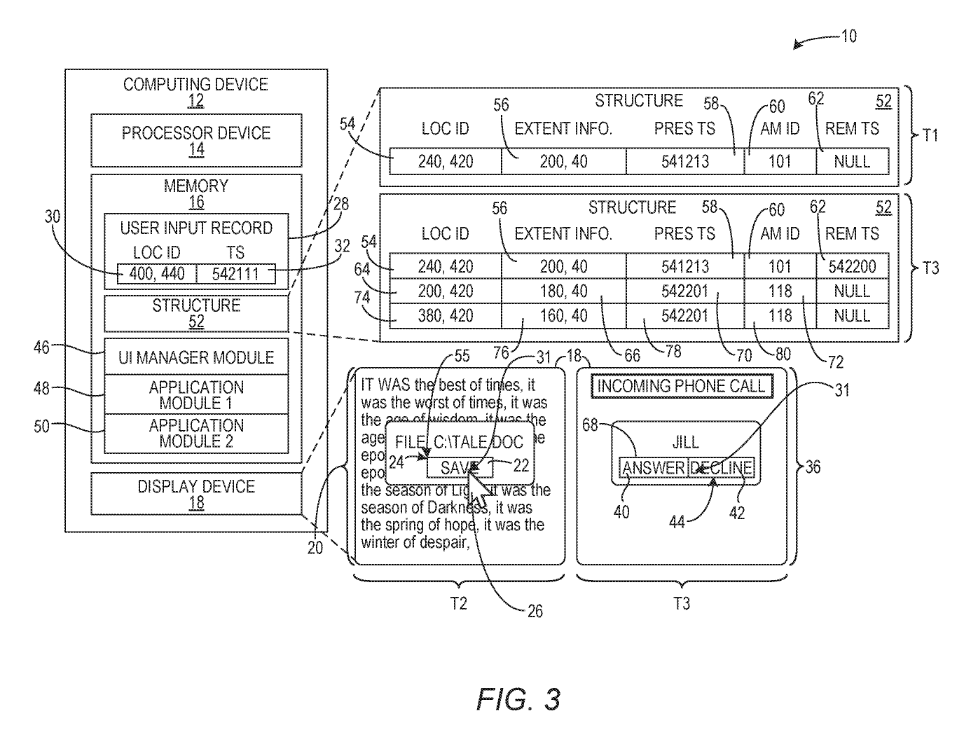

FIG. 3 is a block diagram of the environment 10 illustrated in greater detail. In this example, the computing device 12 includes a UI manager module 46 that generates the user input record 28 upon the receipt of the user input. It is noted that because the UI manager module 46 is a component of the computing device 12, functionality implemented by the UI manager module 46 may be attributed to the computing device 12 generally. Moreover, in examples where the UI manager module 46 comprises software instructions that program the processor device 14 to carry out functionality discussed herein, functionality implemented by the UI manager module 46 may be attributed herein to the processor device 14.

The references to relative times, such as T1, T2, and T3 with regard to FIG. 3 do not necessarily refer to the same references to relative times used above with regard to FIG. 1. For purposes of illustration, assume at the time T1 the application module 48 causes the first UI 20 to be presented on the display device 18. The application module 48 may comprise, for example, a word processing application module. In these examples, the presentation of user interfaces on the display device 18 may be facilitated via the UI manager module 46, which, in addition to recording user inputs, keeps track of when user interfaces are presented on the display device 18 and when user interfaces are removed from the display device 18.

In this example, the UI manager module 46 determines that the first UI 20 includes the user-activatable UI portion 22 that has the activatable extent 24. The UI manager module 46 may determine this, for example, by processing instructions generated by the application module 48 to create the first UI 20, such as HTML instructions or the like. Generally, the UI manager module 46, records, for each user-activatable UI portion of a UI, certain information in a structure 52 maintained in the memory 16. In particular, in this example, for the user-activatable UI portion 22, the UI manager module 46 records a location ID 54 that identifies a location of the user-activatable UI portion 22. The location ID 54 may identify the location of the user-activatable UI portion 22 in any desirable manner. In one example, the location is identified via a pixel location of the uppermost and left-most point 55 of the user-activatable UI portion 22. This location may be referred to via a pixel location of the display device 18 with respect to a reference location of the display device 18. For example, the top and left most pixel of the display device 18 may be location X=0 and Y=0. Positive values of X indicate an offset, to the right, from the first column of pixels of the display device 18. Positive values of Y indicate an offset, down, from the first row of pixels of the display device 18. For example, if the display device 18 comprises a 1000×1000 pixel array, the location 0,0 may refer to the top left of the display device 18, the location 999,0 may refer to the top right of the display device 18, the location 0,999 may refer to the bottom left of the display device 18, and the location 999,999 may refer to the bottom right of the display device 18.

In this example, the location ID 54 identifies the user-activatable UI portion 22 as being located at X=240 and Y=420 of the display device 18. The UI manager module 46 also records extent information 56 that identifies the activatable extent 24 of the user-activatable UI portion 22 with respect to the location of the user-activatable UI portion 22. Again, the extent information 56 may identify the activatable extent 24 in any desired manner, however, for purposes of illustration, the activatable extent 24 will be identified in terms of a rectangle having a top and left most corner originating at the location of the user-activatable UI portion 22 and having a width of X pixels and height of Y pixels. In this example, the extent information 56 comprises 200, 40, and thus is a rectangle having a width of 200 pixels and a height of 40 pixels.

The UI manager module 46 also records a presentation timestamp 58 that identifies the time at which the user-activatable UI portion 22 is first presented in the first UI 20. The UI manager module 46 may also record an application module ID 60 that uniquely identifies the application module 48 as the application module that generated the user-activatable UI portion 22. At the time of presentation the UI manager module 46 may also record a removal timestamp 62 as a NULL value, indicating that the user-activatable UI portion 22 has not been removed from the display device 18.

Assume at a time T2, the user activates the user-activatable UI portion 22 by, for example, placing the cursor 26 within the activatable extent 24 and clicking a mouse button of a mouse that operates in conjunction with the cursor 26. The UI manager module 46, upon receiving the user input that activates the user-activatable UI portion 22, records the user input in the user input record 28. The user input record 28 includes the location identifier (ID) 30 that identifies the selected location 31 of the display device 18, and the user input timestamp 32 that identifies the time of the user input.

Also at the time T2, an application module 50 begins processing an incoming phone call and generates the second UI 36. The application module 50 may comprise, for example, a telephone client application module. At the time T3, the application module 50 presents the second UI 36 on the display device 18 prior to the user input record 28 being processed. The UI manager module 46 stores a removal timestamp 62 that identifies the time the user-activatable UI portion 22 was removed from the display device 18. The UI manager module 46 determines that the second UI 36 includes the user-activatable UI portions 40 and 42, and for the user-activatable UI portion 40 stores a location ID 64 that identifies a top and left most point of the user-activatable UI portion 40, extent information 66 that identifies an activatable extent 68 of the user-activatable UI portion 40 with respect to the location of the user-activatable UI portion 40. The UI manager module 46 also records a presentation timestamp 70 that identifies the time at which the user-activatable UI portion 40 is first presented in the second UI 36. The UI manager module 46 may also record an application module ID 72 that uniquely identifies the application module 50 as the application module that generated the user-activatable UI portion 40.

For the user-activatable UI portion 42 the UI manager module 46 stores a location ID 74 that identifies a top and left most point of the user-activatable UI portion 42, extent information 76 that identifies the activatable extent 44 of the user-activatable UI portion 42 with respect to the location of the user-activatable UI portion 42. The UI manager module 46 also records a presentation timestamp 78 that identifies the time at which the user-activatable UI portion 42 is first presented in the second UI 36. The UI manager module 46 may also record an application module ID 80 that identifies the application module 50 as the application module that generated the user-activatable UI portion 42.

After the presentation of the second UI 36 the UI manager module 46 begins processing the user input record 28. The UI manager module 46 determines that the selected location 31 is within the activatable extent 44 of the user-activatable UI portion 42 of the second UI 36. The UI manager module 46 accesses the user input timestamp 32 of the user input record 28 and the presentation timestamp 78 of the user-activatable UI portion 42 and determines that user input timestamp 32 identifies a time earlier than the presentation timestamp 78. Based on this determination, the UI manager module 46 inhibits processing of the user-activatable UI portion 42. For example, the UI manager module 46 may simply delete the user input record 28 and does not send a message to the application module 50 that identifies the user input.

In another example, the UI manager module 46 may access the structure 52, and based on the presentation timestamp 58 and the removal timestamp 62 of the user-activatable UI portion 22, determine that at the time of the user input the user-activatable UI portion 22 was presented on the display device 18. The UI manager module 46 may then access the application module ID 60 and send a message indicating selection of the selected location 31 to the application module 48 to process the user input. The application module 48 may then process the user input with respect to the first UI 20, which, in this example, may result in the application module 48 saving a file.

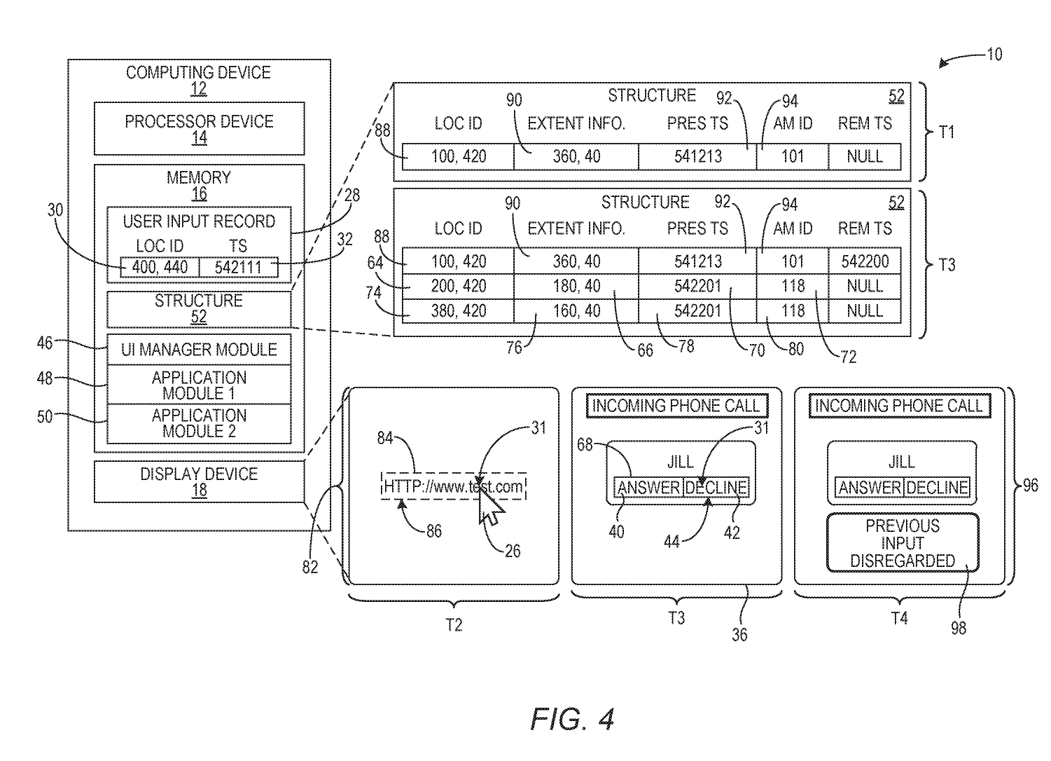

FIG. 4 is a block diagram of the environment 10, according to another example. The references to relative times, such as T1, T2, T3, and T4 with regard to FIG. 4 do not necessarily refer to the same references to relative times used above with regard to FIGS. 1 and 3. For purposes of illustration, assume at the time T1 the application module 48 causes a UI 82 to be presented on the display device 18. The UI 82 includes a user-activatable UI portion 84 that has an activatable extent 86, as indicated in dashed lines. The activatable extent 86 may not be visually depicted to the user, however, the activatable extent 86 defines the area which, if selected, will cause activation of the user-activatable UI portion 84. The UI manager module 46 determines that the UI 82 includes the user-activatable UI portion 84, and for the user-activatable UI portion 84 stores a location ID 88 that identifies a top and left most point of the user-activatable UI portion 84, and extent information 90 that identifies the activatable extent 86 of the user-activatable UI portion 84 with respect to the location of the user-activatable UI portion 84. The UI manager module 46 also records a presentation timestamp 92 that identifies the time at which the user-activatable UI portion 84 is first presented in the UI 82. The UI manager module 46 may also record an application module ID 94 that identifies the application module 48 as the application module that generated the user-activatable UI portion 84. Assume at a time T2, the user activates the user-activatable UI portion 84 by, for example, placing the cursor 26 within the activatable extent 86 and clicking a mouse button of a mouse that operates in conjunction with the cursor 26. The UI manager module 46, upon receiving the user input that activates user-activatable UI portion 84, records the user input in the user input record 28. The user input record 28 includes the location identifier (ID) 30 that identifies the selected location 31 of the display device 18, and the user input timestamp 32 that identifies the time of the user input.

Assume that at the time T2 the application module 50 begins processing an incoming phone call, and generates the second UI 36. At time T3 the application module 50 presents the second UI 36 on the display device 18 prior to the user input record 28 being processed. Further assume that the UI manager module 46 processes the second UI 36 and stores the relevant information in the structure 52 for the user-activatable UI portions 40 and 42 as discussed above with regard to FIG. 3. After the presentation of the second UI 36, the UI manager module 46 begins processing the user input record 28. The UI manager module 46 determines that the selected location 31 is within the activatable extent 44 of the user-activatable UI portion 42 of the second UI 36. The UI manager module 46 accesses the user input timestamp 32 of the user input record 28 and the presentation timestamp 78 of the user-activatable UI portion 42 and determines that user input timestamp 32 identifies a time earlier than the presentation timestamp 78. Based on this determination, the UI manager module 46 inhibits processing of the user-activatable UI portion 42. In this example, the UI manager module 46, at a time T3, presents a UI 96 that includes a message 98 that indicates that the activation of the user-activatable UI portion 42 is inhibited. In particular, in this example, the message 98 indicates that the previous user input will be disregarded.

While for purposes of illustration only a single user input record 28 has been discussed, it should be apparent that additional user inputs may be received prior to processing the user input record 28. In such event, each user input may result in the generation and recording of a corresponding user input record 28, such that a queue of user input records 28 are to be processed. In one example, all user inputs having user input timestamps older than the presentation timestamp of a user-activatable UI portion having an activatable extent that encompasses the location ID of the corresponding user input may be disregarded. In other examples, the UI manager module 46 may process each user input record 28, determine the user-activatable UI portion that was presented at the time of receipt of the user input, and send a message identifying the user input to the application module that generated the user-activatable UI portion for processing. This may be done, for example, in reverse chronological order such that the oldest user inputs are processed first.

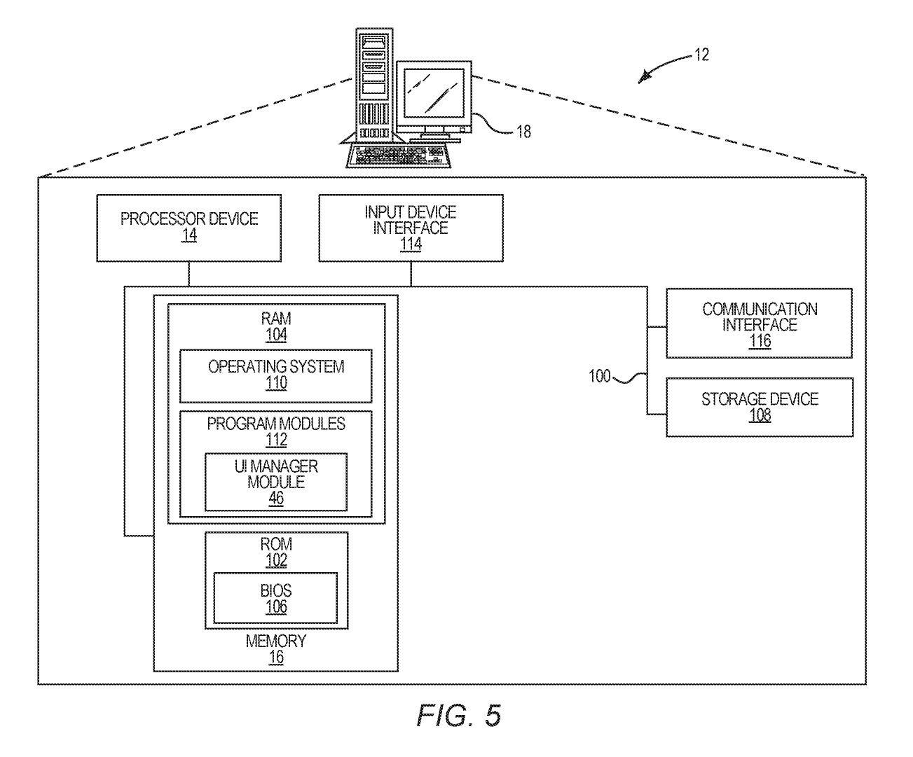

FIG. 5 is a block diagram of the computing device 12 suitable for implementing examples, according to one example. The computing device 12 may comprise any computing or electronic device capable of including firmware, hardware, and/or executing software instructions to implement the functionality described herein, such as a computer, a smartphone, a computing tablet, or the like. The computing device 12 includes the processor device 14, the memory 16, and a system bus 100. The system bus 100 provides an interface for system components including, but not limited to, the memory 16 and the processor device 14. The processor device 14 can be any commercially available or proprietary processor.

The system bus 100 may be any of several types of bus structures that may further interconnect to a memory bus (with or without a memory controller), a peripheral bus, and/or a local bus using any of a variety of commercially available bus architectures. The memory 16 may include non-volatile memory 102 (e.g., read-only memory (ROM), erasable programmable read-only memory (EPROM), electrically erasable programmable read-only memory (EEPROM), etc.), and volatile memory 104 (e.g., random-access memory (RAM)). A basic input/output system (BIOS) 106 may be stored in the non-volatile memory 102 and can include the basic routines that help to transfer information between elements within the computing device 12. The volatile memory 104 may also include a high-speed RAM, such as static RAM, for caching data.

The computing device 12 may further include or be coupled to a non-transitory computer-readable storage medium such as a storage device 108, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 108 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as Zip disks, magnetic cassettes, flash memory cards, cartridges, and the like, may also be used in the operating environment, and further, that any such media may contain computer-executable instructions for performing novel methods of the disclosed examples.

A number of modules can be stored in the storage device 108 and in the volatile memory 104, including an operating system 110 and one or more program modules 112, such as the UI manager module 46, which may implement the functionality described herein in whole or in part. It is to be appreciated that the examples can be implemented with various commercially available operating systems 110 or combinations of operating systems 110.

All or a portion of the examples may be implemented as a computer program product stored on a transitory or non-transitory computer-usable or computer-readable storage medium, such as the storage device 108, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the UI manager module 46 in the volatile memory 104, may serve as a controller, or control system, for the computing device 12 that is to implement the functionality described herein.

A user may use, for example, a keyboard (not illustrated), a pointing device such as a mouse (not illustrated), or a touch-sensitive surface such as the display device 18 to activate a user-activatable UI portion presented on the display device 18. Such input devices may be connected to the processor device 14 through an input device interface 114 that is coupled to the system bus 100 but can be connected by other interfaces such as a parallel port, an Institute of Electrical and Electronic Engineers (IEEE) 1394 serial port, a Universal Serial Bus (USB) port, an IR interface, and the like. The computing device 12 may also include a communication interface 116 suitable for communicating with a network as appropriate or desired.

Individuals will recognize improvements and modifications to the preferred examples of the disclosure. All such improvements and modifications are considered within the scope of the concepts disclosed herein and the claims that follow.

What is claimed is:

1. A method comprising:
receiving, at a first time by a computing device comprising a processor device, user input that identifies a selected location on a display device that is presenting a first user interface (UI) at the first time;
storing, in a memory, a user input record that includes a location identifier (ID) that identifies the selected location and a user input timestamp that identifies the first time;
presenting, at a second time, on the display device a second UI that is different from the first UI, the second UI including a user-activatable UI portion having an activatable extent that includes the selected location;
initiating, after the second time, processing of the user input record;
determining that the user input timestamp identifies a time earlier than the second time; and
inhibiting activation of the user-activatable UI portion.

2. The method of claim 1 further comprising storing, in the memory:
a location ID that identifies a location of the user-activatable UI portion;
extent information that identifies the activatable extent of the user-activatable UI portion with respect to the location; and
a presentation timestamp identifying the second time.

3. The method of claim 2 wherein initiating, after the second time, processing of the user input record further comprises determining that the selected location is within the activatable extent of the user-activatable UI portion; and
wherein determining that the user input timestamp identifies the time earlier than the second time comprises determining that the user input timestamp is earlier than the presentation timestamp.

4. The method of claim 1 wherein initiating, after the second time, processing of the user input record further comprises:
determining that at the first time a different user-activatable UI portion having an activatable extent included the selected location;
determining an application module that generated the different user-activatable UI portion; and
sending a message identifying the user input to the application module for processing the user input with respect to the different user-activatable UI portion.

5. The method of claim 4 wherein determining that at the first time the different user-activatable UI portion having the activatable extent included the selected location comprises:
accessing a structure that identifies a plurality of user-activatable UI portions, and for each respective user-activatable UI portion identifies:
a location identifier (ID) that identifies a location on the display device at which the respective user-activatable UI portion was presented;
extent information that identifies an activatable extent of the respective user-activatable UI portion;
a presentation timestamp that identifies a time at which the respective user-activatable UI portion was presented on the display device;
a removal timestamp that identifies a time at which the respective user-activatable UI portion was removed from the display device; and
an application module identifier that identifies an application module that generated the respective user-activatable UI portion.

6. The method of claim 5 wherein accessing the structure that identifies the plurality of user-activatable UI portions further comprises:
identifying the different user-activatable UI portion by determining that:
the activatable extent of the different user-activatable UI portion includes the selected location;
the presentation timestamp of the different user-activatable UI portion identifies a time earlier than the user input timestamp; and
the removal timestamp of the different user-activatable UI portion identifies a time later than the user input timestamp.

7. The method of claim 1 further comprising:
presenting, prior to the first time, the first UI on the display device, the first UI comprising a first user-activatable UI portion having an activatable extent that includes the selected location; and
storing, in the memory:
a location identifier (ID) that identifies a location on the display device at which the first user-activatable UI portion was presented;
extent information that identifies the activatable extent of the first user-activatable UI portion; and
a presentation timestamp that identifies a time at which the first user-activatable UI portion was presented on the display device.

8. The method of claim 7 further comprising:
storing, at the second time, a removal timestamp that identifies a time at which the first user-activatable UI portion was removed from the display device.

9. The method of claim 1 further comprising presenting a message on the display device that indicates that activation of the user-activatable UI portion is inhibited.

10. The method of claim 1 wherein the user input comprises a click event associated with a mouse pointer that is located at the selected location.

11. The method of claim 1 wherein the user input comprises a touch event associated with a user contacting the display device at the selected location.

12. A computing device comprising:
a memory; and
a processor device coupled to the memory to:
receive, at a first time, user input that identifies a selected location on a display device that is presenting a first user interface (UI) at the first time;
store, in the memory, a user input record that includes a location identifier (ID) that identifies the selected location and a user input timestamp that identifies the first time;
present, at a second time, on the display device a second UI that is different from the first UI, the second UI including a user-activatable UI portion having an activatable extent that includes the selected location;
initiate, after the second time, processing of the user input record;
determine that the user input timestamp identifies a time earlier than the second time; and
inhibit activation of the user-activatable UI portion.

13. The computing device of claim 12 wherein the processor device is further to store, in the memory:
a location ID that identifies a location of the user-activatable UI portion;
extent information that identifies the activatable extent of the user-activatable UI portion with respect to the location; and
a presentation timestamp identifying the second time.

14. The computing device of claim 13 wherein to initiate, after the second time, processing of the user input record, the processor device is further to:
determine that at the first time a different user-activatable UI portion having an activatable extent included the selected location;
determine an application module that generated the different user-activatable UI portion; and
send a message identifying the user input to the application module for processing the user input with respect to the different user-activatable UI portion.

15. The computing device of claim 12 wherein the processor device is further to:
present, prior to the first time, the first UI on the display device, the first UI comprising a first user-activatable UI portion having an activatable extent that includes the selected location; and
store, in the memory:
a location ID that identifies a location on the display device at which the first user-activatable UI portion was presented;
extent information that identifies the activatable extent of the first user-activatable UI portion; and
a presentation timestamp that identifies a time at which the first user-activatable UI portion was presented on the display device.

16. The computing device of claim 15 wherein the processor device is further to store, at the second time, a removal timestamp that identifies a time at which the first user-activatable UI portion was removed from the display device.

17. A computer program product stored on a non-transitory computer-readable storage medium and including instructions configured to cause a processor device to:
receive, at a first time, user input that identifies a selected location on a display device that is presenting a first user interface (UI) at the first time;
store, in a memory, a user input record that includes a location identifier (ID) that identifies the selected location and a user input timestamp that identifies the first time;
present, at a second time, on the display device a second UI that is different from the first UI, the second UI including a user-activatable UI portion having an activatable extent that includes the selected location;
initiate, after the second time, processing of the user input record;
determine that the user input timestamp identifies a time earlier than the second time; and
inhibit activation of the user-activatable UI portion.

18. The computer program product of claim 17 wherein the instructions are further configured to cause the processor device to store, in the memory:
a location ID that identifies a location of the user-activatable UI portion;
extent information that identifies the activatable extent of the user-activatable UI portion with respect to the location; and
a presentation timestamp identifying the second time.

19. The computer program product of claim 18 wherein the instructions that configured to cause the processor device to initiate, after the second time processing of the user input record, are further configured to cause the processor device to:
determine that at the first time a different user-activatable UI portion having an activatable extent included the selected location;
determine an application module that generated the different user-activatable UI portion; and
send a message identifying the user input to the application module for processing the user input with respect to the different user-activatable UI portion.

20. The computer program product of claim 17 wherein the instructions are further configured to cause the processor device to:
present, prior to the first time, the first UI on the display device, the first UI comprising a first user-activatable UI portion having an activatable extent that includes the selected location; and
store, in the memory:
a location identifier (ID) that identifies a location on the display device at which the first user-activatable UI portion was presented;
extent information that identifies the activatable extent of the first user-activatable UI portion; and
a presentation timestamp that identifies a time at which the first user-activatable UI portion was presented on the display device.
